(19) United States
(12) Patent Application Publication
(10) Pub. No.: US 2005/0036180 A1
(43) Pub. Date: Feb. 17, 2005

(54) Optical system having a holographic optical element

(76) Inventor: Paul Michael Petersen, Hillerod (DE)

Correspondence Address: BIRCH STEWART KOLASCH & BIRCH, PO BOX 747, FALLS CHURCH, VA, 22040-0747, US

(21) Appl. No.: 10/451,724

(22) PCT Filed: Dec. 21, 2001
(86) PCT No.: PCT/DK01/00866

Related U.S. Application Data
(60) Provisional application No. 60/258,351, filed on Dec. 28, 2000.

(51) Int. Cl. G02B 5/32

(52) U.S. Cl. 359/15

(57) ABSTRACT

An optical laser system wherein a holographic optical element (HOE) replaces a bulky feedback system comprising a large number of optical element. The feedback system is adjusted so that the laser device and the feedback system cooperate to select a state having a high temporal and/or spatial coherence, and the optical properties of the optical elements are recorded into the HOE. When the feedback system is removed the HOE reproduces the properties of the optical elements of the feedback system. The laser system is compact in size, cheap to manufacture, has high mechanical stability, and is less fragile than ordinary feedback systems. The laser system may be used in environments, such as the printing industry, which normally do not permit an ordinary feedback system, e.g. due to mechanical vibrations or misalignment due to temperature variations. A number of centre frequencies may be multiplexed into the HOE. May be mass produced. Furthermore, a method of producing such an optical laser system.

### FIELD OF THE INVENTION

The present invention relates to an optical system, in particular a compact optical system comprising a holographic optical element and to the use of a compact optical system in a laser system so as to provide a compact laser system with good spatial and temporal coherence.

### BACKGROUND OF THE INVENTION

From WO 98/56087, it is known to use phase conjugate feedback in a laser system in order to obtain a highly coherent, possibly single mode, output light beam. However, the laser system disclosed in WO 98/56087 requires a number of optical elements. Such optical elements are expensive, especially if one of the optical elements comprises an anisotropic ferroelectric crystal, such as a BaTiO₃ crystal. Furthermore, BaTiO₃ crystals have a phase transition near room temperature and consequently they are very fragile and therefore need to be handled with much care. In addition to this, using a large number of optical elements requires a precise alignment of the elements, and it also results in a bulky laser system which is sensitive to mechanical vibrations. The alignment may be difficult to obtain and especially to preserve outside of a laboratory, and, furthermore, the bulky laser system is not very convenient for the user.

‘In Holographic optical head for compact disk applications’, Optical Engineering, Vol. 28(6), pp 650-653, June 1989, is disclosed an optical head for a CD player based on the holographic optical element and laser/detector hybrid technology. The holographic optical elements disclosed in this document are adapted to replace a number of refractive elements, such as lenses, beamsplitters, and diffraction gratings, or optionally a simple mirror. The document further discloses a method of fabrication of computer-generated holographic optical elements.

A number of references describe the use of a holographic optical element (HOE) for replacing one or more optical elements. However, none of these references disclose using a HOE for injecting the beam back into the laser in order to improve the spatial and/or temporal properties of the output beam. The HOE is rather used for compensating for ‘beam defects’, such as astigmatism, after the beam has been output from the optical system.

WO 99/57579 discloses a method for designing and constructing miniature optical systems and devices employing light diffractive optical elements (DOEs) for modifying the size and shape of laser beams produced from commercial-grade laser diodes. The DOEs may be implemented as holographic optical elements (HOEs). The DOE compensates for ‘beam defects’, such as astigmatism, of a beam emitted from a laser system. The beam is not injected back into the laser.

U.S. Pat. No. 6,018,402 discloses the use of a holographic optical element (HOE) to reconstruct optical elements typically used to phaseencode an object beam emanating from a spatial light modulator (SLM). The HOE replaces the complicated phase mask and conventional four-F lens system arrangement typically used to phase-encode an amplitude-encoded object beam emanating from the SLM. Thus, the HOE is in this case used for converting and transforming laser light from one state to another.

‘Recent studies of miniaturization of optical disk pickups in Japan’ by Hiroshi Nishihara, Proceedings of the SPIE—The International Society for Optical Engineering, 1990, USA, vol. 1248, pages 88-95, XP001029989, describes methods for improving pickups for compact disk players. A holographic optical element may be used for improving the output power of the diode laser. Thus, the temporal and/or spatial properties of the beam are not affected by the HOE.

It is, furthermore, known to produce holographic optical elements, e.g. for producing bright, sharp, three-dimensional images.

In contrast to the applications of HOE and DOE mentioned above the present invention deals with the improvement of the spatial and temporal coherence of high power laser diodes when the HOE or DOE is used to feedback light into the active region of the high power laser diode.

### SUMMARY OF THE INVENTION

It is an object of the present invention to provide a laser system which is compact and cheap to manufacture, which is less fragile than known laser systems, and which is less sensitive to misalignment of the optical elements which may be caused, e.g., by mechanical vibrations, temperature changes, etc.

It is a further object to provide methods of manufacturing a laser system having the properties described above.

It is an even further object to provide an optical system having a simple optical component which provides a passive feedback to the laser system.

It is an even further object to provide an optical system in which the output beam has been subject to losses which are substantially smaller than losses caused by known feedback systems.

It is an even further object to provide a feedback system with a high mechanical stability.

It is an even further object to provide an optical system which is capable of producing an output beam having better spatial and/or temporal properties than the output beam from known systems.

It is a very important object of the invention to provide a diode laser system with high output power, in the range of 1 W to 1000 W, which can be focused to a small diffraction limited spot.

According to a first aspect of the present invention there is provided an optical system for emission of an output light beam, wherein a holographic optical element reproduces the optical properties of a plurality of optical elements, the plurality of optical elements forming a feedback system being adapted to cooperate with a laser device to select a high temporal and/or spatial coherent state of the laser device.

The output light beam is emitted from the optical system, i.e. it is available for other purposes. That is, the output light beam may be used as a source of electromagnetic radiation. Thus, the output light beam is an electromagnetic output beam, such as a light beam, an ultraviolet beam, a microwave beam, an X-ray beam, or any other suitable kind of electromagnetic beam.

The optical properties of the optical elements may be any suitable kind of optical properties, such as refractive index, reflectivity, selection of, e.g., frequencies or spatial modes, frequency doubling, etc., depending on which kinds of optical elements are used.

The plurality of optical elements which may be reproduced by the holographic optical element form a feedback system being adapted to cooperate with a laser device to select a high temporal and/or spatial coherent state of the laser device.

The laser device, thus, being adapted to supply a first light beam to the optical system, and the laser device and the holographic optical element reproducing the optical properties of the optical system may then cooperate to select a high temporal and/or spatial coherent state of the laser device.

The feedback system used to improve the coherence properties of laser systems may be an optical system reflecting at least a part of the first light beam emitted from the laser device back into the laser device. In cooperation, the feedback system and the laser device then force the laser device to emit laser radiation with a high temporal and/or spatial coherence. When a high temporal coherent state is selected, the output light beam of the system, thus, comprises radiation within a very narrow frequency range, and, preferably, the output light beam substantially comprises only a single frequency. When a high spatial coherent state is selected the output light beam may be focused to a small spot size of the order of a wavelength. This is an important property for a large number of applications.

Preferably, at least one of the plurality of optical elements is selected from the group consisting of:
spatial filters,
gratings,
mirrors,
Fabry Perot etalons,
frequency filters.

It is a great advantage of the present invention that a HOE is used as a feedback system. Thus, a HOE is substantially less expensive than a large number of optical elements.

Furthermore, the size of the entire optical system is substantially reduced, and the system is much more stable, e.g. with respect to vibrations, misalignments, etc. Thus, the HOE may be attached to the laser facet itself, thereby substantially improving the mechanical stability properties of the optical system. Also, the HOE provides a passive feedback system as opposed to the active feedback system provided by a feedback system comprising non-linear optical components. This is a great advantage because in comparison with the active feedback the passive feedback only uses low cost elements. Finally, a feedback system being represented by a HOE may introduce fewer losses than a feedback system comprising the actual optical components which the HOE represents. This is because it is possible to let the HOE reproduce other optical properties of the individual optical component without reproducing the loss characteristics of that component. In case the HOE represent a large number of optical components, this is a very important advantage since the entire system may introduce very heavy losses.

A spatial filter may, e.g., be an aperture, a slit, a pinhole or any other suitable kind of spatial filter. The optical properties of a spatial filter which may be reproduced by the holographic optical element in this case preferably comprise selection of specific modes or frequencies.

In case one of the optical elements is a grating, the optical properties to be reproduced by the holographic optical element preferably comprise a frequency selectivity.

In case one of the optical elements is a mirror, the optical properties to be reproduced by the holographic optical element preferably comprise the reflective properties of the mirror, such as a frequency dependent reflectivity, i.e. the reflectivity of the mirror at a certain frequency, the tilt angle of the mirror, and/or any focusing properties of the mirror. The mirror may be a plane mirror, a parabolic mirror, a spherical mirror, a mirror with a spatial selectivity, or a mirror having any other suitable shape.

A frequency filter may e.g. comprise a grating, such as a diffractive optical element, preferably in combination with a spatial filter, such as an aperture or a slit, or it may be a filter which transmits electromagnetic radiation within a specific frequency range and reflects or absorbs any other frequencies. It may comprise an interference filter, an absorbance filter, such as a semiconductor doped glass, an etalon, such as a Fabry Perot element, a prism etc. The frequency filter may be adapted to select a range of frequencies, preferably a narrow range, most preferably a single frequency. In case one of the optical elements is a frequency filter, the optical properties to be reproduced by the holographic optical element preferably comprise frequency selection, transmission/reflection/absorption properties, selection of modes, reflective properties, refractive index, transmission properties, reflectivity, interference properties (destructive and/or constructive), or any other suitable properties of the frequency filter.

According to a second aspect the present invention further provides a method of producing an optical system for emission of an output light beam, the method comprising the steps of:
inserting a holographic recording material into an external cavity formed between a laser device and a feedback system, said feedback system comprising a plurality of optical elements,
emitting, by means of the laser device, a first light beam, at least part of said first light beam illuminating at least part of the feedback system via said holographic recording material,
adjusting the feedback system so that the laser device and the feedback system cooperate to select a state having a high temporal and/or spatial coherence,
recording a holographic optical element in the holographic recording material,
developing the holographic optical element so that the holographic optical element is adapted to reproduce the optical properties of the plurality of optical element when said feedback system is removed, and
removing the feedback system.

The holographic recording material may be any material with a photosensitive refractive index and/or absorption coefficient for example a dichromatic gelatine, a Silver Bromide (AgBr) solution, photo resist, and/or a photorefractive medium.

The laser device may be a single laser, e.g. a gas laser, a semiconductor laser, a broad area laser, a superluminescent laser diode, a dye laser, a Nd-YAG laser, an argon ion laser, a titanium sapphire laser, an F-center laser, or any other suitable kind of laser. It may also be an array of lasers, said lasers being of any of the types mentioned above.

The feedback system is defined above.

Adjusting the feedback system may comprise adjusting one or more of the optical elements forming the feedback system in such a way that a state having a high temporal and/or spatial coherency is selected. The adjusting step may, furthermore, comprise alignment of the optical elements. Additionally or alternatively, the adjusting step may comprise adjusting one or more optical element(s) in such a way that, e.g., a certain frequency, a certain spatial mode, etc. is selected. This may, for example, be done in the following way.

In a preferred embodiment of the invention, the feedback system comprises a reflector, the reflector being adapted to reflect at least a part of the first light beam emitted by the laser device back into the laser device. The free running laser emits a large number of spatial modes. By using spatial filtering for example in the Fourier plane, e.g. by means of one or more spatial filter(s), such as aperture(s), slit(s), pinhole(s), etc., the system is adjusted to emit laser light having a high temporal and/or spatial coherency. The feedback system may, furthermore, comprise a grating or an etalon so that the frequency of the first light beam may be tuned by tilting the grating or the etalon. It is, thus, possible to adjust the system to emit an output light beam having, e.g., a certain spatial mode, frequency, etc., depending on the optical elements being provided in the feedback system.

When the feedback system has been adjusted so that the output light beam has the desired properties, a holographic optical element having these properties is recorded in the holographic recording material positioned between the laser device and the feedback system. When the holographic optical element is subsequently developed, it will thus be adapted to reproduce the optical properties of the elements in the feedback system. The feedback system may then be removed and the holographic optical element will act as the feedback system, i.e. the output beam will have the same desired properties which the feedback system was adjusted to provide. Of course, the recorded and developed holographic optical element itself may not afterwards be adjusted as the feedback system, thus, limiting the flexibility of the system. However, it is an advantage of the system according to the present invention that the system provided is substantially non-sensitive to misalignments due to vibrations, temperature variations, etc. It is a further advantage that a rather bulky, expensive, and fragile feedback system may be replaced by the compact, cheap, and reliable holographic optical element. These advantages makes the system very advantageous for commercial purposes. It is, thus, possible to use to system under conditions which are normally not suited for a feedback system comprising a large number of fragile optical components, e.g. in an environment introducing vibrations, temperature variations, a dirty environment, etc. It is possible to manufacture HOEs under ideal conditions and subsequently position the HOEs in optical systems under less ideal conditions. Thus, an ideal feedback system is provided even though the environment is not suited for such a feedback system. Furthermore, the price of the entire system will be sufficiently low to attract potential customers. The system may, thus, advantageously be used, e.g., in the printing industry, medical applications, or telecommunication.

In a very preferred embodiment laser systems having a HOE replacing a feedback system may be mass produced by recording one HOE by the method described above, and subsequently reproduce this HOE. The reproduced HOEs may then be positioned in laser systems having similar properties. It should be noted that the HOE in each case should be positioned in the laser system in a position corresponding to the position in which the original HOE was recorded in order for the HOE to properly reproduce the feedback system. Such mass produced laser systems are very advantageous from a commercial point of view since they are very cheap to manufacture, and the price therefore will be acceptable for potential customers.

The method may comprise the steps of, for each of the optical elements:
adjusting the feedback system so that the laser device and the feedback system cooperate to select a state having a high temporal and/or spatial coherency,
recording a holographic optical element in the holographic recording material,
repeating the adjusting and recording steps until the properties of each of the plurality of optical elements has been recorded, and
performing the development after the optical properties of all the optical elements have been recorded and removing the feedback system when the holographic optical element has been developed.

In this case, the adjusting and recording steps are performed for each optical element of the feedback system. Thus, each optical element is in turn adjusted to achieve a desired optical property of the optical element in question. This optical property is then recorded. In order to record the optical properties of all the optical elements into the same holographic optical element, the holographic optical recording material is not developed until all the optical properties have been recorded.

At least one of the plurality of optical elements may be selected from the group consisting of:
spatial filters,
gratings,
mirrors,
Fabry Perot etalons,
frequency filters.

These optical elements and their optical properties have been described above.

Preferably, the method further comprises the step of positioning the holographic optical element in connection with a laser device, so that the holographic optical element and the laser device may cooperate to select a state having a high temporal and/or spatial coherency.

That is, the holographic optical element may preferably be used to replace the feedback system in order to provide a compact, cheap, and mechanically stable laser system as described above, and as will be further described below.

The method may further comprise the step of multiplexing a plurality of centre frequencies into the holographic optical element. In an embodiment where the feedback system comprises a grating, this may be performed in the following way.

The feedback system may be adjusted to select one centre frequency and a corresponding grating may be induced in the holographic optical element. The laser device may then be turned off and the grating be tilted to select a new centre frequency. When the laser device is turned on again, a new hologram with a new centre frequency may be written into the holographic optical recording material. By repeating this procedure for each centre frequency, a plurality of frequencies are written into the holographic recording material. When all the desired frequencies have been written into the holographic recording material, the holographic optical element is developed, so as to obtain a holographic optical element having all the desired centre frequencies multiplexed into it.

Thus, the method may further comprise the steps of, for each of the plurality of centre frequencies:
adjusting the feedback system to emit a centre frequency feedback light beam so that the laser device and the feedback system cooperate to select a state having a high temporal and/or spatial coherency, and so that a specific centre frequency is obtained,
recording a holographic optical element in the holographic recording material,
repeating the adjusting and recording steps until each of the plurality of centre frequencies has been recorded, and
performing the development after all the centre frequencies have been recorded and removing the feedback system when the holographic optical element has been developed.

The developing step may be performed using a chemical or thermal fixing procedure. Alternatively, the holographic recording material may be of a kind which is ‘self-developing’. In this case the development is performed automatically and does not require an active act. This is known per se.

The laser system may advantageously be a compact laser system.

According to a third aspect the invention further provides a compact laser system for emission of an output light beam, the system comprising:
a laser device for emission of a first light beam, and
a holographic optical element being illuminated by at least a part of the first light beam, thereby causing a feedback light beam to be emitted from the holographic optical element and being reinjected into the active gain medium of the laser device, whereby the laser device and the holographic optical element cooperate to select a high spatial and/or high temporal coherent state of the laser device, whereby the laser system is controlled to emit an output light beam having an improved spatial and/or temporal coherence.

As described above the laser device may be any suitable kind of laser device, such as a gas laser, a semiconductor laser, a superluminescent laser diode, a dye laser, a Nd-YAG laser, an argon ion laser, a titanium sapphire laser, an F-center laser, or any other suitable kind of laser. It may also be an array of lasers, said lasers being of any of the types mentioned above.

The first light beam may be an electromagnetic beam, preferably a monochromatic electromagnetic beam. In case the laser device is a single laser, the first light may also be a coherent light beam. In case the laser device is an array of lasers or another laser device having a broad bandwidth gain medium, the first light beam will in most cases have a very low degree of coherence.

The holographic optical element is illuminated by at least part of the first light beam. It may, of course, be illuminated by all of the first light beam. At least part of the holographic optical element may be illuminated, or all of the holographic optical element may be illuminated.

The feedback light beam is emitted from the holographic optical element in response to the first light beam illuminating the holographic optical element. The feedback light beam may be an electromagnetic beam, such as an electromagnetic beam comprising frequencies within the visible frequency range, the ultraviolet frequency range, the infrared frequency range, the X-ray frequency range, or any other suitable frequency range. The feedback light beam may be e.g. a complete reflection of the first light beam. Alternatively, it may be a reflected part of the first light beam, such as a part defined by a specific frequency range, a specific polarisation, a specific spatial mode, etc. Alternatively, the feedback light beam may be a beam which is generated by the holographic optical element in response to the first light beam.

The feedback light beam is reinjected into the active gain medium of the laser device. In this way the laser device and the holographic optical element cooperate to select a high spatial and/or temporal coherent state of the laser device. The output light beam from the system will then have a high spatial and/or temporal coherent state.

In order to obtain a high power, the laser device is often an array of lasers as described above. As mentioned above, this will very often result in a first light beam having a low degree of coherence. Since the output light beam has a high spatial and/or temporal coherent state, it thus has an improved spatial and/or temporal coherence as compared to the first light beam being emitted from the laser device. Thereby, the compact laser system is adapted for improving the coherency of a high power laser beam.

The holographic optical element may be adapted to reconstruct an original light beam from a feedback system.

The feedback system may comprise a number of optical elements as described above, and it is preferably operated as described above.

The holographic optical element may, thus, replace the bulky, expensive, and fragile optical elements of the feedback system. Since a holographic optical element is compact, cheap, and less fragile than most ordinary optical elements, the resulting laser system will also be compact, cheap, and less fragile than laser systems having an ordinary feedback system comprising a number of optical elements. Furthermore, the resulting laser system will not be subject to misalignments due to, e.g., vibrations or temperature variations to the same extend that an ordinary laser system is.

The feedback system may comprise one or more optical elements selected from the group consisting of:
spatial filters,
gratings,
lenses,
mirrors,
Fabry Perot etalons,
frequency filters.

Most of these optical elements as well as their optical properties have been described above. The original light beam from the feedback system which the holographic optical element is adapted to reconstruct, preferably comprises information relating to the optical properties of the optical elements of the feedback system. The holographic optical element is most preferably recorded in such a way that these optical properties may be reproduced by the holographic optical element. Thus, the output light beam from the compact laser system may be substantially identical to the output light beam from a more bulky laser system having an ordinary feedback system.

In case one of the optical elements is a lens, the optical properties to be reproduced by the holographic optical element preferably comprise refractive index, reflectivity, including internal reflectivity, focal length, radius of curvature, or any other suitable optical properties of the lens. The lens may be an ordinary concave or convex lens, or it may be another kind of refractive optical element, such as a prism.

The holographic optical element may be adapted to, in cooperation with the laser device, select at least one centre frequency from the first light beam. This corresponds to selecting a high temporal coherent state. However, the exact value of the centre frequency may also be selected in this embodiment. This may e.g. be obtained by recording the holographic optical element using a feedback system which may be tuned so as to select a specific frequency.

The holographic optical element may be adapted to, in cooperation with the laser device, select a plurality of centre frequencies, each centre frequency being multiplexed into the holographic optical element.

This may be obtained by consecutively tuning a system as described above to each of the plurality of centre frequencies, and recording and developing the holographic optical element in such a way that all the centre frequencies are multiplexed into the holographic optical element. This procedure will be further described below.

The laser device may comprise a laser array, such as an array of diode lasers, gas lasers, semiconductor lasers, dye lasers, Nd-YAG lasers, argon ion lasers, or any other suitable kind of lasers. Alternatively, it may be a single laser as described above.

The laser device may comprise at least one laser selected from the group consisting of:
broad area lasers,
laser diode arrays,
laser diode bars,
stacked laser arrays.

Broad area lasers and laser diode arrays comprise a number of diode lasers arranged in a row.

Laser diode bars also comprise a number of diode lasers arranged in a row. However, the lasers of a laser diode bar are spatially separated, so that the light sources may be considered as a number of discrete point sources.

Stacked laser arrays comprise a number of laser diode bars being stacked, so as to form a two-dimensional array of diode lasers.

The above-mentioned types of lasers all provide an output beam having a high power, but a low degree of coherence. For some applications, it may therefore be necessary to improve the coherency of the output beam. This may be done as previously described.

According to a fourth aspect the invention further provides a method of generating an output light beam from a laser system, the laser system comprising a laser device and a holographic optical element, the method comprising the steps of:
emitting, by means of the laser device, a first light beam in such a way that at least part of the holographic optical element is illuminated by at least part of the first light beam,
injecting, by means of the holographic optical element and in response to the first light beam, a feedback light beam into the laser device, and
outputting, by means of the holographic optical element and in response to the first light beam, an output light beam from the laser system, said output light beam having an improved spatial and/or temporal coherence state.

The first light beam, the feedback light beam, as well as the output light beam may be electromagnetic beams as described above.

All of, or at least part of, the holographic optical element may be illuminated by the first light beam, and it may be illuminated by all of, or at least part of, the first light beam.

The feedback light beam may be a fully or a partial reflection of the first light beam, or it may be generated by the holographic optical element, as described above.

The laser device and the holographic optical element cooperate to select a state having a high temporal and/or spatial coherence, so that the output light beam has an improved spatial and/or temporal coherence as compared to the first light beam which is initially emitted from the laser device. This has been described above.

The holographic optical element may reconstruct an original light beam from a feedback system. This has already been described.

The feedback system may comprise one or more optical elements selected from the group consisting of:
spatial filters,
gratings,
lenses,
mirrors,
Fabry Perot etalons,
frequency filters.

These optical elements as well as their optical properties have been described above.

The method may further comprise the step of, by means of the holographic optical element in cooperation with the laser device, selecting at least one centre frequency from the first light beam. As described above this corresponds to selecting a state having a high temporal coherence. However, a specific frequency is chosen in this case.

The method may further comprise the step of, by means of the holographic optical element in cooperation with the laser device, selecting a plurality of centre frequencies, each centre frequency having previously been multiplexed into the holographic optical element. This has also been described above.

According to a fifth aspect the invention further provides a method of producing a compact laser system for emission of an output light beam, the method comprising the steps of:
inserting a holographic recording material into a laser cavity formed between a laser device and a feedback system,
emitting, by means of the laser device, a first light beam, at least part of said first light beam illuminating at least part of the feedback system via said holographic recording material,
adjusting the feedback system to emit a feedback light beam so that the laser device and the feedback system cooperate to select a state having a high temporal and/or spatial coherency,
recording a holographic optical element in the holographic recording material,
developing the holographic optical element so that the holographic optical element is capable of reconstructing the feedback light beam from the feedback system when said feedback system is removed, and
removing the feedback system.

The laser device may be any suitable kind of laser device as described above. The feedback system preferably comprises a number of optical elements each having specific optical properties.

The first light beam as well as the feedback light beam may be electromagnetic beams as described above.

The adjusting step is preferably performed by adjusting each of the optical elements of the feedback system. This may comprise tilting gratings to the correct angle, e.g. in order to obtain a specific frequency, positioning spatial filters correctly, e.g. in order to obtain a specific spatial mode, aligning the optical elements, e.g. in order to optimise the throughput of the system, and/or it may comprise any other suitable kind of adjusting of the feedback system. The adjusting step results in that the laser device and the feedback system, by means of the feedback light beam, cooperate to select a state having a high temporal and/or spatial coherency. The adjusting may be performed using spatial filtering in the Fourier plan.

The holographic recording material may comprise a dichromatic gelatine, a silver bromide (AgBr) solution, photo resist, and/or a photorefractive medium, such as a lithium niobate crystal.

When the holographic optical recording material has been developed to form the holographic optical element, the holographic optical element is capable of reconstructing the feedback light beam from the feedback system because the optical properties of the optical elements of the feedback system have been recorded into the holographic optical element. When the feedback system is removed, the laser device and the holographic optical element may therefore be able to cooperate to select a state having a high temporal and/or spatial coherency. That is, the output light beam emitted from the laser system with the feedback system removed will be substantially identical to the output light beam emitted from the laser system with the feedback system present instead of the holographic optical element. Thus, as described above, the holographic optical element may replace the rather bulky, expensive, etc. feedback system, thereby providing a laser system which is compact, cheap, etc.

The method may further comprise the step of multiplexing a plurality of centre frequencies into the holographic optical element.

Thus, the method may further comprise the steps of, for each of the plurality of centre frequencies:
adjusting the feedback system to emit a centre frequency feedback light beam so that the laser device and the feedback system cooperate to select a state having a high temporal and/or spatial coherency, and so that a specific centre frequency is obtained,
recording a holographic optical element in the holographic recording material,
repeating the adjusting and recording steps until each of the plurality of centre frequencies has been recorded, and
performing the development after all the centre frequencies have been recorded and removing the feedback system when the holographic optical element has been developed.

This has already been described above.

A laser system according to the present invention may be used for a number of various applications, such as frequency doubling, coupling of light into thin core or single mode laser fibres, material processing, the printing industry, biomedical application, and/or any other suitable applications in which a compact, low cost, and reliable laser system is useful.

The first, second, third, fourth, and fifth aspects of the present invention may each be combined with one or more of the other aspects of the present invention.

### BRIEF DESCRIPTION OF THE DRAWINGS

FIG. 1 shows the recording of a feedback system into a holographic optical element,

in FIG. 2, the holographic optical element has been developed and the feedback system has been removed,

FIG. 3 shows an example of a feedback system comprising a laser diode array receiving an external feedback from a reflector, and

FIG. 4 shows an example of an output from a laser operating simultaneously at several wavelengths.

### DETAILED DESCRIPTION OF THE DRAWINGS

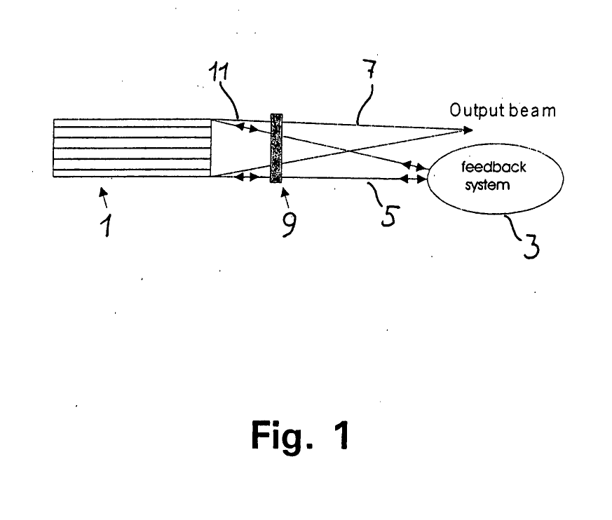

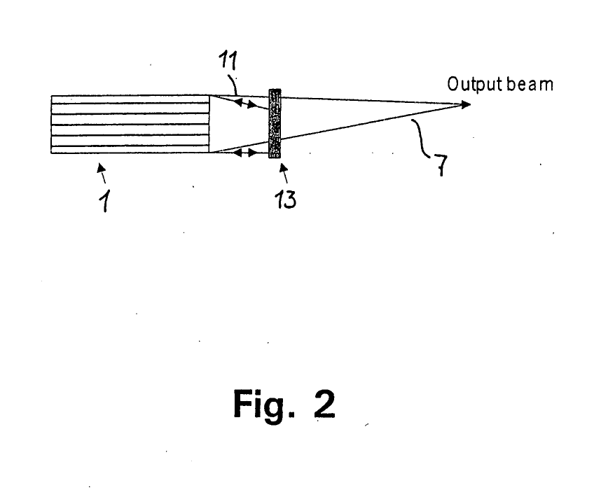

In FIG. 1, a laser diode array 1 and an external cavity formed between the laser diode array 1 and the feedback system 3 is shown. The laser array 1 receives a feedback signal from the feedback system 3. The laser beam 11 emitted from the laser array 1 forms a twin lobe structure in the plane of the far field, and one of the lobes, the lobe 5, illuminates the feedback system 3 whereas the other lobe 7 provides an output light beam.

A holographic optical recording material 9 is inserted in the path of the laser beam 11 between the laser array 1 and the feedback system 3, preferably, the holographic optical recording material 9 is inserted proximate to the laser array 1 emitting the laser beam 11 so that the resulting laser system may be minimised as much as possible. It is, though, emphasised that the holographic optical recording material may be inserted just after the laser or anywhere in the feedback system.

According to a preferred embodiment of the present invention, the feedback system 3 is a frequency selective feedback system adjusted to select a high spatial and/or a high temporal coherent state of the laser array 1. Having adjusted the laser system to inject a feedback signal into the laser array 1 to select a high spatial and/or high temporal coherent state of the laser array 1, the holographic optical recording material 9 is developed either spontaneously or by a chemical and/or thermal procedure.

In FIG. 2, the optical system comprising the developed holographic optical element 13 is shown. The feedback system 3 is removed and the developed holographic optical element 13 is inserted in the path of the laser beam 11 at the same position as the position on which the holographic optical recording material 9 was recorded. The holographic optical element 13 hereby reconstructs the original signal from the feedback system (now removed) which is injected into the laser array 1, and in the preferred embodiment mentioned above, the holographic optical element 13 and the laser array 1 will select a high spatial and/or temporal coherent state of the laser array 1 whereby the laser array 1 is adapted to emit a high spatial and/or high temporal coherent output light beam 7. The holographic optical element may be of a material such as dichromatic gelatines, silver bromide, photo resist, or a photo-refractive medium, such as a lithium niobate crystal.

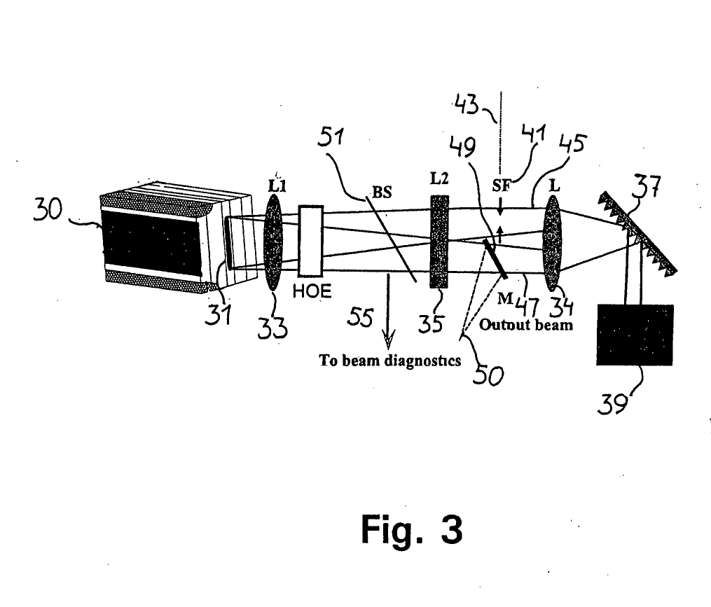

FIG. 3 shows an example of a frequency selective feedback system according to the preferred embodiment mentioned above. In FIG. 3, the entire laser beam 11 illuminates the holographic optical recording material.

The laser array 30 used in the embodiment shown in FIG. 3 is a SDL-2432 GaAlAs broad area laser with a threshold of 0.29 Amps and a maximum output power of 0.5 Watts at a drive current of 0.75 Amps. The lasing wavelength at 20.0° C. is 813.5 nm and the emitting junction 31 is 1×100 μm.

The light emitted from the laser array 30 is collimated with a Thorlab C230TM-B lens 33 with an effective focal length of 4.5 mm and a numerical aperture of 0.55. A beam splitter 51 is inserted in the system to couple a part of the beam 55 out for beam diagnostics. A cylindrical lens 35 with a focal length of 150 mm is inserted to collimate the beam.

Furthermore, an etalon may be provided causing the feedback to be frequency selective, the etalon may be a Fabry-Perot etalon with a finesse of approx. 17. Alternatively, an etalon having a lower finesse, such as approx. 2.6 may be used. The etalon, thus, improves the temporal coherence of the output beam. All lenses and etalons have a broad band anti-reflection coating (R<1 percent) in order to minimise the loss of the external cavity. Furthermore, the exit face of the laser may have antireflection coating to improve the influence from the feedback system. The external cavity is terminated by a grating 37 and a reflector 39, the reflector 39 being a mirror or in a preferred embodiment, a four-wave mixing non-linear medium, such as a GaAlAs crystal arranged in a self-pumped configuration.

A spatial filter 41 is inserted in the lobe 45 in the plane of the pseudo far field 43, whereby only selected spatial modes of the lobe 45 are directed towards the grating and the reflector. In the other lobe 47, a mirror 49 is inserted for coupling an output light beam out of the system.

To record this system into a holographic optical recording medium, the holographic optical recording medium is positioned in the laser beam 11 after the collimating lens 33. When the system is adjusted to emit an output light beam having a high spatial and/or temporal coherence, the holographic optical recording medium is developed and the feedback system comprising lenses 34, 35, beam splitter 51, mirror 49, spatial filter 41, grating 37 and reflector 39, may be removed.

Hereby, the complex optical system shown in FIG. 3 may be replaced by a single holographic optical element, whereby the size of the optical system is dramatically reduced. Furthermore, adjustment of gratings, spatial filters, etalons, etc, is avoided during operation or start-up of the system, since this adjustment is inherently present in the holographic optical element. The holographic optical element need only to be inserted at the same position in relation to the laser array or laser device as the position of holographic optical recording medium during recording of the medium. This reduces the overall cost and complexity of the system, and for example very fragile and expensive components, such as non-linear mediums, may be replaced by a low-cost and reliable holographic optical element, and the fragile and expensive mediums may be used to record a plurality of holographic optical elements in controlled environments. A further advantage of the described system is that all components may be integrated on a single chip.

The frequency selective feedback system may, as described in connection with FIG. 3, be a grating based feedback system comprising a mirror, a spatial filter, grating and lenses. In an alternative preferred embodiment, the frequency selective feedback system may comprise gratings, lenses and a spatial filter. In a still further preferred embodiment of the invention, the frequency selective feedback system comprises non-linear four-wave mixing in combination with gratings, spatial filters and frequency filters.

The grating is a frequency filter which only refracts a limited number of frequencies which then interact with the reflector. By tilting the grating so that the feedback beam is adjusted to match the lasing wavelength of a spatial mode with high gain in the laser array, the frequency of the output beam is tuned. Similarly, an etalon in combination with a non-linear four-wave mixing medium passes only a limited number of frequencies so that, as the reflectivity of the non-linear four-wave mixing medium increases, the spectrum narrows down significantly. Single spatial mode operation can be achieved if the orientation of the etalon is adjusted so the wavelength for peak transmission match the lasing wavelengths of a spatial mode with high gain or centre frequencies of the laser array.

Advantage of the possibility of tilting the grating 37 or the etalon (not shown in FIG. 3) for selecting a specific lasing wavelength of the laser array may be taken when recording a holographic optical recording medium.

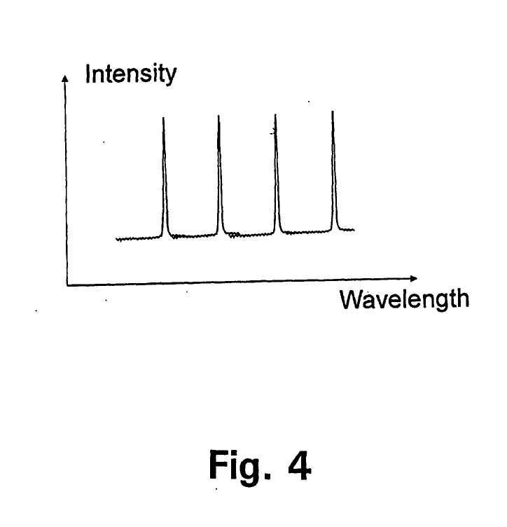

By having the holographic optical recording medium positioned in the optical system, the tilting angle of the grating may be varied. At a first centre frequency, a first holographic grating according to the tilting angle of the grating may be recorded in the holographic optical recording medium. The laser array is then turned off and the grating is tilted to select a new centre frequency. When the laser is turned on, a new hologram with a new centre frequency, a new holographic grating, is written into the holographic optical recording medium. By using this procedure at a plurality of centre frequencies, a plurality of holographic gratings are written into the holographic optical recording medium. When a predetermined number of frequencies have been written into the material, the material is developed and afterwards the holographic optical element may be used to provide an output as illustrated in FIG. 4, where a number of four centre frequencies has been written into the holographic optical recording medium before developing the medium. The configuration used to obtain the output shown in FIG. 4 is a configuration according to the configuration shown in FIG. 2.

The possibility of multiplexing a number of centre frequencies into an holographic optical element enables the laser array or any other laser device to operate simultaneously at several wavelengths. This is an especially important feature in high capacity telecommunication systems.

1. An optical system for emission of an output light beam, wherein a holographic optical element reproduces the optical properties of a plurality of optical elements, the plurality of optical elements forming a feedback system being adapted to cooperate with a laser device to select a high temporal and/or spatial coherent state of the laser device.

2. An optical system according to claim 1, wherein at least one of the plurality of optical elements is selected from the group consisting of:
spatial filters,
gratings,
mirrors,
Fabry Perot etalons,
frequency filters.

3. A method of producing an optical system for emission of an output beam, the method comprising the steps of:
inserting a holographic recording material into an external cavity formed between a laser device and a feedback system, said feedback system comprising a plurality of optical elements,
emitting, by means of the laser device, a first light beam, at least part of said first light beam illuminating at least part of the feedback system via said holographic recording material,
adjusting the feedback system so that the laser device and the feedback system cooperate to select a state having a high temporal and/or spatial coherence,
recording a holographic optical element in the holographic recording material,
developing the holographic optical element so that the holographic optical element is adapted to reproduce the optical properties of the plurality of optical element when said feedback system is removed, and
removing the feedback system.

4. A method according to claim 3, the method comprising the steps of, for each of the optical elements:
adjusting the feedback system so that the laser device and the feedback system cooperate to select a state having a high temporal and/or spatial coherency,
recording a holographic optical element in the holographic recording material,
repeating the adjusting and recording steps until the properties of eachof the plurality of optical elements has been recorded, and
performing the development after the optical properties of all the optical elements have been recorded and removing the feedback system when the holographic optical element has been developed.

5. A method according to claim 3 or 4, wherein at least one of the plurality of optical elements is selected from the group consisting of:
spatial filters,
gratings,
mirrors,
Fabry Perot etalons,
frequency filters.

6. A method according to any of claims 3-5, further comprising the step of positioning the holographic optical element in connection with a laser device, so that the holographic optical element and the laser device may cooperate to select a state having a high temporal and/or spatial coherency.

7. A method according to any of claims 4-6, further comprising the step of multiplexing a plurality of centre frequencies into the holographic optical element.

8. A method according to claim 7, the method further comprising the steps of, for each of the plurality of centre frequencies:
adjusting the feedback system to emit a centre frequency feedback light beam so that the laser device and the feedback system cooperate to select a state having a high temporal and/or spatial coherency, and so that a specific centre frequency is obtained,
recording a holographic optical element in the holographic recording material,
repeating the adjusting and recording steps until each of the plurality of centre frequencies has been recorded, and
performing the development after all the centre frequencies have been recorded and removing the feedback system when the holographic optical element has been developed.

9. A method according to any of claims 3-8, wherein the developing step is performed using a chemical or thermal fixing procedure.

10. A method according to any of claims 3-9, wherein the laser system is a compact laser system.

11. A compact laser system for emission of an output light beam, the system comprising:
alaser device for emission of a first light beam, and
a holographic optical element being illuminated by at least a part of the first light beam, thereby causing a feedback light beam to be emitted from the holographic optical element and being reinjected into the active gain medium of the laser device, whereby the laser device and the holographic optical element cooperate to select a high spatial and/or high temporal coherent state of the laser device, whereby the laser system is controlled to emit an output light beam having an improved spatial and/or temporal coherence.

12. A laser system according to claim11, wherein the holographic optical element is adapted to reconstruct an original light beam from a feedback system.

13. A laser system according to claim 12, wherein the feedback system comprises one or more optical elements selected from the group consisting of:
spatial filters,
gratings,
lenses,
mirrors,
Fabry Perot etalons,
frequency filters.

14. A laser system according to any of claims 11-13, wherein the holographic optical element is adapted to, in coopreation with the laser device, select at least one centre frequency from the first light beam.

15. A laser system according to any of claims 11-14, wherein the holographic optical element is adapted to, in cooperation with the laser device, select a plurality of centre frequencies, each centre frequency being multiplexed into the holographic optical element.

16. A laser system according to any of claims 11-15, wherein the laser device comprises a laser array.

17. A laser system according to any of claims 11-16, wherein the laser device comprises at least one laser selected from the group consisting of:
broad area lasers,
laser diode arrays,
laser diode bars,
stacked laser arrays.

18. A method of generating an output light beam from a laser system comprising a laser device and a holographic optical element, the method comprising the steps of:
emitting, by means of the laser device, a first light beam in such a way tha t at least part of the holographic optical element is illuminated by at least part of the first light beam,
injecting, by means of the holographic optical element and in response to the first light beam, a feedback light beam into the laser device, and
outputting, by means of the holographic optical element and in response to the first light beam, an output light beam from the laser system, said output light beam having an imptoved spatial and/or temporal coherence state.

19. A method according to claim 18, wherein the feedback system comprises one or more optical elements selected from the groupt consisting of:
spatial filters,
gratings,
lenses,
mirrors,
Fabry Perot etalons,
frequency filters.

21. A method according to any of claims 18-20, further comprising the steps of, by means of the holographic optical element in cooperation with the laser device, selecting at least one centre frequency from the first light beam.

22. A method according to any of claim 18-21, further comprising the steps of, by menas of the holographic optical element in cooperation with the laser device, selecting at least one centre frequency from the first light beam.

23. A method of producing a compact laser system for emission of an output light beam, the method comprising the steps of:
inserting a holographic recording material into a laser cavity formed between a laser device and a feedback system,
emitting, by means of te laser device, a first light beam, at least part of said first light beam illuminating at least part of the feedback system via said holographic recording material,
adjusting the feedback system to emit a feedback light beam so that the laser device and the feedback system cooperate to select a state having a high temporal and/or spatial coherency,
recording a holographic optical element in the holographic recording material,
developing the holographic optical element so that the holographic optical element is capable of reconstructing the feedback light beam from the feedback system when said feedback system is removed, and
removing the feedback system.

24. A method according to claim 23, further comprising the step of multiplexing a plurality of centre frequencies into the holographic optical element.

25. A method according to claim 24, the method further comprising the steps of, for each of the plurality of centre frequencies:
adjusting the feedback system to emit a centre frequency feedback light beam so that the laser device and the feedback system cooperate to select a state having a high temporal and/or spatial coherency, and so that a specific centre frequency is obtained,
recording a holographic optical element in the holographic recording material,
repeating the adjusting and recording steps until each of the plurality of centre frequencies has been recorded, and
performing the development after all the centre frequencies have been recorded and removing the feedback system when the holographic optical element has been developed.

26. A method according to any of claims 23-25, wherein the developing step is performed using a chemical or thermal fixing procedure.
